(19) United States
(12) Patent Application Publication
(10) Pub. No.: US 2020/0081873 A1
(43) Pub. Date: Mar. 12, 2020

(54) SYSTEM AND SERVER FOR BEST-FIT DATA STORAGE

(71) Applicant: AVEVA Software, LLC, Lake Forest, CA (US)

(72) Inventors: Vinay T. Kamath, Rancho Santa Margarita, CA (US); Shiewun Lie, Mission Viejo, CA (US); Ali Sadigh, Cambridge (GB); Elliott Scott Middleton, JR., Tyler, TX (US)

(21) Appl. No.: 16/566,705

(22) Filed: Sep. 10, 2019

Related U.S. Application Data
(60) Provisional application No. 62/729,362, filed on Sep. 10, 2018.

(51) Int. Cl. G06F 16/21; G06F 16/17; G06F 16/28; G06F 16/2457; G06F 16/25

(52) U.S. Cl. CPC G06F 16/217; G06F 16/219; G06F 16/254; G06F 16/28; G06F 16/24573; G06F 16/1734

(57) ABSTRACT

Some embodiments include computer-implemented method and system operating the method including a first step of receiving input data from an operational historian during a time interval, where the input data is derived from at least a portion of the operational state data. If the time interval has exceeded a specified time interval, then resetting base data values, and outputting stored input data to a computer-readable storage medium of the network. If the time interval has not exceeded a specified time interval, then comparing the input data with base values, and if any of the input data exceeds at least one of the base values, then updating the base values and proceeding to the first step. Further, if any of the input data does not exceed at least one of the base values, then discarding the input data and proceeding to the first step of the method.

### CROSS-REFERENCE TO RELATED APPLICATIONS

This application claims the benefit of and priority to United States provisional patent application No. 62/729,362, filed Sep. 10, 2018, entitled, “SYSTEM FOR BEST-FIT DATA STORAGE SYSTEM AND METHOD”, the entire contents of which are incorporated herein by reference.

### BACKGROUND

In various industrial fields related to data acquisition and storage, it is often desirable to store time-series data of a sensor or other observable source of data for an extended length of time. However, when the data originate from multiple sources and are stored for a long time, the accumulated stored data volume can grow and become expensive and cumbersome to analyze and manage.

Accordingly, there exists a need for systems and methods to summarize and/or compress time-series data before it is stored in a time-series database. Such a system and method could be utilized to efficiently store important information in successive time intervals without losing critical information.

### SUMMARY OF THE INVENTION

Some embodiments include a server system comprising program logic tangibly stored on at least one non-transitory computer-readable storage medium of a network. In some embodiments, the network includes at least one processor coupled to a historian that is configured to receive operational state data from at least one device of an industrial process of the network. In some embodiments, upon execution of at least a portion of the program logic by the at least one processor, the at least one processor is configured to process steps of a method including a first step of receiving input data from the historian during a time interval. Some further embodiments include the step of calculating if the time interval has exceeded a specified time interval, and if the time interval has exceeded a specified time interval, then performing the steps of resetting base data values, and outputting stored input data to the at least one non-transitory computer-readable storage medium of the network. Further, if the time interval has not exceeded a specified time interval, then performing the step of comparing the input data with the base values, and if any of the input data exceeds at least one of the base values, then updating base values and proceeding to the first step. Further, if any of the input data does not exceed at least one of the base values, then discarding the input data and proceeding to the first step.

In some embodiments, the specified time interval comprises at least one cycle duration. In some embodiments, the at least one cycle duration comprises a fixed cycle duration dependent on at least one of a data source and at least one user. In some further embodiments, a resolution of the specified time interval is defined by a rate limit that is dynamic per the at least one user. In some embodiments, the specified time interval comprises two cycles. In some embodiments, the base values include a first value in a cycle, a minimum value in the cycle, maximum value in the cycle, a last value in the cycle, and/or an exception value in the cycle.

In some embodiments, the input data includes time-series data received from the at least one device. In some embodiments, the operational state data comprises at least one of metadata, event data, configuration data, raw time-series binary data, tag metadata, and diagnostic log data.

In some embodiments, the at least one device includes one or more components of a fluid processing system. In some embodiments, the one or more components comprise at least one of at least one pump, at least one valve, at least one sensor, and at least one process controller.

Some embodiments include a computer-implemented method comprising the steps of a first step of receiving input data from an operational historian during a time interval. The operational historian is coupled to a network and receives operational state data from at least one device of an industrial process of the network, where at least a portion of the input data is derived from at least a portion of the operational state data. In some embodiments, a further step of the method can include using at least one processor, calculating if the time interval has exceeded a specified time interval, and if the time interval has exceeded a specified time interval, then performing the steps of resetting base data values, and outputting stored input data to at least one non-transitory computer-readable storage medium of the network. Further, if the time interval has not exceeded a specified time interval, then performing the step of using the at least one processor comparing the input data with base values, and if any of the input data exceeds at least one of the base values, then updating the base values and proceeding to the first step. Further, if any of the input data does not exceed at least one of the base values, then discarding the input data and proceeding to the first step of the method.

In some embodiments of the method, the specified time interval comprises at least one cycle duration. In some further embodiments of the method, the at least one cycle duration comprises a fixed cycle duration dependent on at least one of a data source and at least one user. In some embodiments of the method, the resolution of the specified time interval is defined by a rate limit that is dynamic per the at least one user. In some further embodiments of the method, the specified time interval comprises two cycles. In some further embodiments of the method, the input data includes time-series data received from the at least one device. In some embodiments of the method, the operational state data comprises at least one of metadata, event data, configuration data, raw time-series binary data, tag metadata, and diagnostic log data.

In some embodiments of the method, the at least one device includes one or more components of a fluid processing system. In some embodiments of the method, the one or more components comprise at least one of at least one pump, at least one valve, at least one sensor, and at least one process controller. In some embodiments of the method, the base values include a first value in a cycle, a minimum value in the cycle, maximum value in the cycle, a last value in the cycle, and/or an exception value in the cycle.

### DESCRIPTION OF THE DRAWINGS

FIG. 1 depicts an example historian of one or more embodiments of the invention.

FIG. 2 illustrates an industrial process system of one or more embodiments of the invention.

FIG. 3A illustrates a process for a best-fit data storage in accordance with some embodiments of the invention.

FIG. 3B shows a non-limiting example of data point selection using a best-fit process of the invention.

FIG. 4 illustrates a system architecture of a computing device of the operational historian according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments relate to improved processing and display of data in electronic devices including, for example, a computer or computer server (e.g., such as a computer system or server functioning as a manufacturing execution system) that provides a technological solution where users can more efficiently monitor processes, retrieve, process, and view useful data. Some embodiments include a system and method for arranging, structuring, and transmitting data or datasets in a computer or computer server using one or more data streams. Further, the embodiments of the invention herein generally describe non-conventional approaches for data processing systems and methods that are not well-known, and further, are not taught or suggested by any known conventional methods or systems. Moreover, the specific functional features are a significant technological improvement over conventional methods and systems, including at least the operation and functioning of a computing system that are technological improvements. These technological improvements include one or more aspects of the systems and method described herein that describe the specifics of how a machine operates, which the Federal Circuit makes clear is the essence of statutory subject matter.

One or more of the embodiments described herein include functional limitations that cooperate in an ordered combination to transform the operation of a data repository in a way that improves the problem of data storage and updating of databases that previously existed. In particular, some embodiments described herein include system and methods for managing single or multiple content data items across disparate sources or applications that create a problem for users of such systems and services, and where maintaining reliable control over distributed information is difficult or impossible.

The description herein further describes some embodiments that provide novel features that improve the performance of communication and software, systems and servers by providing automated functionality that effectively and more efficiently manages resources and asset data for a user in a way that cannot effectively be done manually. Therefore, the person of ordinary skill can easily recognize that these functions provide the automated functionality, as described herein, in a manner that is not well-known, and certainly not conventional. As such, the embodiments of the invention described herein are not directed to an abstract idea and further provide significantly more tangible innovation. Moreover, the functionalities described herein were not imaginable in previously-existing computing systems, and did not exist until some embodiments of the invention solved the technical problem described earlier.

Some embodiments of the invention can enable a significant reduction in the overall volume of data in an operational historian system, while maintaining critical information about the original data. In some embodiments, this reduces storage and computational requirements significantly. Some embodiments of the invention can significantly reduce communication bandwidth required to transmit data. Some embodiments of the invention can operate to handle non-varying and repetitive samples efficiently. Some embodiments can maintain critical (to the field) information related to one or more signals (e.g., signals from an industrial process, machine, and/or component) in successive time intervals.

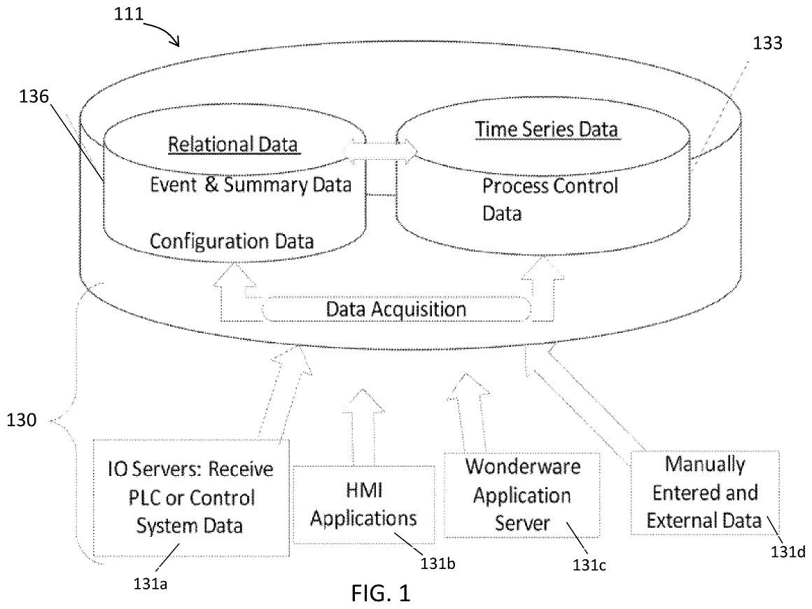

In general, an operational historian can store (e.g., “historize”) various types of data related to one or more industrial processes including data received from sensors or probes. Some example data includes, but is not limited to, time-series data, metadata, event data, configuration data, raw time-series binary data, tag metadata, diagnostic log data, and the like. An operational historian can usually be adapted to record trends and historical information about the industrial process for future reference. Further, an operational historian can analyze process related data stored in an operational historian database and transforms that data into timely reports that are communicated one or more user devices. In this manner, an operational historian can filter (e.g., curate) data in order to raise visibility of the data to users (e.g., via user devices) without overwhelming them and/or overburdening communications networks. For example, FIG. 1 depicts a non-limiting example historian 111 that has the capability to securely provide and obtain configuration data of an industrial process. In some embodiments, the historian 111 includes a time-series database 133 and a relational database 136 according to an embodiment of the invention. In at least one embodiment, the time-series database 133 and the relational database 136 can each derive data from various sources during data acquisition 130, including, but not limited to, one or more servers 131a, one or more human-machine-interface (HMI) applications 131b, at least one application server 131c, and manually entered and/or external data 131d. In some embodiments, time-series data can in part be provided by process control data stored in the time-series database 133, where the time-series data can be representative of historical plant process information such as, for example, a continuum of process flow values measured over a period of time. In some non-limiting embodiments, configuration data can, at least in part, be provided by the relational database 136, such as, configuration settings for a cloud service and associated storage capability utilized by the historian 111. In some embodiments, the historian 111 can comprise processor-executable instructions embodied on a storage memory device (e.g., as part of a server computing device) to provide the operational historian via a software environment in Wonderware® Historian and Wonderware® Online provided by Schneider Electric.

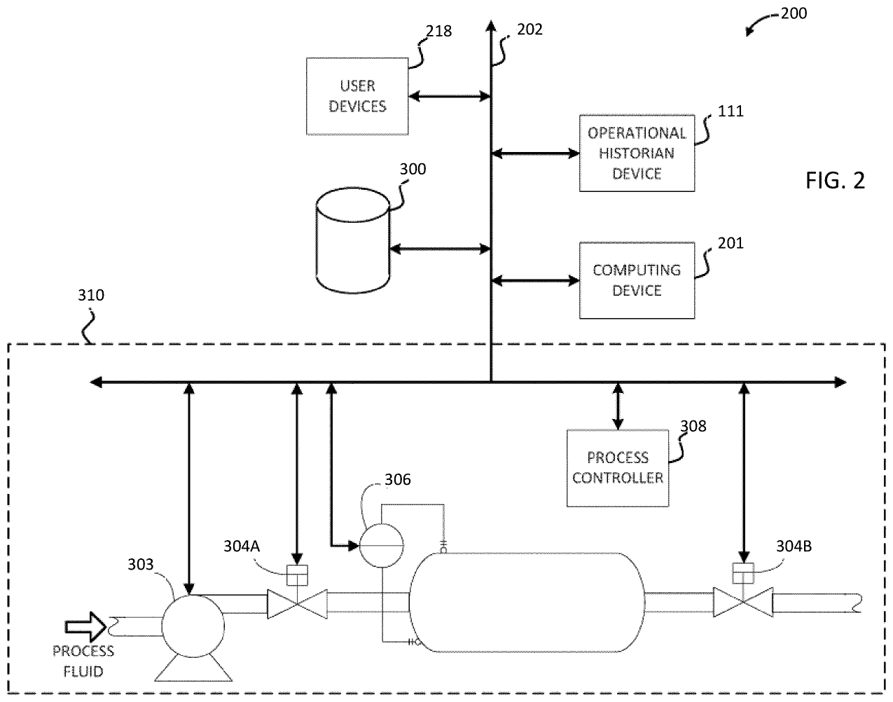

In some embodiments, an operational historian 111 can store data about various aspects of an industrial process in quantities that humans cannot interpret or analyze. For example, an operational historian may receive two million or more data values (e.g., tags relating to process control components, process variables, etc.) every second. For example, FIG. 2 illustrates a non-limiting example embodiment of an industrial process system 200 including a coupled historian 111. In some embodiments, the system 200 can include at least one computing device 201, at least one coupled database 300, at least one user device 218, at least one communication network 202, and at least a portion of a coupled industrial system such as fluid processing system 310. As a non-limiting example embodiment, the fluid processing system 310 can be adapted for changing or refining raw materials to create end products. Further, some aspects of the invention are capable of optimizing processes and processing systems other than fluid processing system 310 and that system 310 is presented for illustration purposes only. Additional example processes include, but are not limited to, those in the chemical, oil and gas, food and beverage, pharmaceutical, water treatment, and power industries.

In some embodiments, the operational historian 111 can be adapted to store (e.g., “historize”) various types of data related to one or more of the operational or current states of the fluid processing system 310, including data related to one or more of the operational or current states of one or more components of the fluid processing system 310. By way of example, in some embodiments, the fluid processing system 310 of this non-limiting embodiment includes at least one pump 303, one or more valves 304A, 304B, at least one sensor 306, and at least one process controller 308. In system 200, the computing device 201, operational historian device 111, database 300, user devices 218, and one or more components of the fluid processing system 310 (e.g., pump 303, valve 304A and/or valve 304B, one or more sensors 306, process controller 308) can be communicatively connected via the communication network 202. In some embodiments, the communication network 202 can facilitate the exchange of data among the historian 111, computing device 201, database 300, user devices 218, and one or more components of the fluid processing system 310. In an embodiment, process controller 308 provides an interface or gateway between components of fluid processing system 310 (e.g., pump 303, valves 304, one or more sensors 306) and other components of system 300 (e.g., historian 111, computing device 201, and user devices 218). In another embodiment, components of fluid processing system 310 can communicate directly with the historian 111, and/or computing device 201, and/or user devices 218 via the communication network 202. In yet another embodiment, the process controller 308 can transmit data to and receive data from pump 303, and/or one or more valves 304A, 304B, and/or one or more sensors 306 for controlling and/or monitoring various aspects of fluid processing system 310. Thus, in some embodiments, the one or more sensors 306 can provide data derived from one or more components of an industrial system, including, but not limited to, operational and/or state data.

In some embodiments, the communication network 302 can be a local area network (LAN) coupled to one or more other telecommunications networks, including other LANs or portions of the Internet or an intranet. In some embodiments, the communication network 302 may be any telecommunications network that facilitates the exchange of data, such as those that operate according to the IEEE 802.3 (e.g., Ethernet) and/or the IEEE 802.11 (e.g., Wi-Fi). Alternatively, the communication network 302 can be any medium that allows data to be physically transferred through serial or parallel communication channels (e.g., copper, wire, optical fiber, computer bus, wireless communication channel, etc.). In an embodiment, communication network 302 comprises at least in part a process control network.

Some embodiments of the invention include various methods, apparatuses (including computer systems) that perform such methods, and computer readable media containing instructions that, when executed by computing systems, cause the computing systems to perform such methods. For example, non-limiting embodiments can comprise certain software instructions or program logic stored on at least one non-transitory computer-readable storage medium for tangibly storing thereon program logic for execution by at least one processor of the system or coupled to the system.

For the purposes of this disclosure the term “server” should be understood to refer to a service point which provides processing, database, and communication facilities. A computing device (e.g., such as computing device 201) may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as a Microsoft® Windows® Server, Mac OS X, Unix, Linux, and/or any other conventional operating system. Microsoft® and Windows® are registered trademarks of Microsoft Corporation, Redmond, Wash.

For the purposes of this disclosure a “network” should be understood to refer to a network that may couple devices so that communications may be exchanged, such as between a server and a client device, peer to peer communications, or other types of devices, including between wireless devices coupled via a wireless network, for example. A network may also include mass storage, such as network attached storage (NAS), a storage area network (SAN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, “Integrated Services Digital Networks” (ISDNs), “Digital Subscriber Lines” (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple user or client devices with a network. A wireless network may employ stand-alone ad-hoc networks, mesh networks, wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including “Long Term Evolution” (LTE), WLAN, wireless router (WR) mesh, or 2nd, 3rd, 4th, or 5th generation (2G, 3G, 4G, or 5G) cellular technology, or the like. Network access technologies may enable wide area coverage for devices, such as client devices with varying degrees of mobility, for example. For example, a network may enable RF or wireless type communication via one or more network access technologies, such as “Global System for Mobile communication” (GSM), “Universal Mobile Telecommunications System” (UMTS), “General Packet Radio Services” (GPRS), “Enhanced Data GSM Environment” (EDGE), 3GPP LTE, LTE Advanced, “Wideband Code Division Multiple Access” (WCDMA), Bluetooth®, 802.11b/g/n, or the like. A wireless network may include virtually any type of wireless communication mechanism by which signals may be communicated between devices, such as a client device or a computing device, between or within a network, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a near field communication (NFC) device, a personal digital assistant (PDA), a handheld computer, a tablet computer, a phablet, a laptop computer, a set top box, a wearable computer, an integrated device combining various features, such as features of the forgoing devices, or the like.

Some embodiments include a computer-implemented method comprising program logic executed by at least one processor of a computer system that can provide an environment that allows users to utilize a graphical user interface (GUI) to visualize data or blocks of data, monitor data and alarms, including one or more transitions to or from an alarm or alert state. For example, the historian 111 may provide a tool for use by a user that enables the user to monitor storage blocks and functionality, and that enables a user to observe incoming event data, the merging of snapshots in a storage block, and responses to queries. This information may be conveyed to a user in the form of text and/or graphics in the GUI. The GUI may have a variety of icons indicating different event data, storage blocks, or snapshots, and alarms. Further, some embodiments include a computer-implemented method that includes: retrieving, by a computer system from a data store, a file comprising a plurality of data; displaying data or updating the display based at least in part on data or information related to the file via a display screen of a user interface in communication with the computer system. In some embodiments of the invention, the display can include a display of a computer system, a personal digital assistant, a cellular or smart phone, a digital tablet, and/or other fixed or mobile Internet appliances.

Some embodiments comprise or utilize a best-fit storage filter that can significantly reduce the storage burden and overhead of one or more historian systems such as historian 111. In some embodiments, this reduction of data can be done by only recording the first, last, minimum, maximum and the first base value sample of the data in each interval. Using these methods, in some embodiments, the system and method can enable at least a partial reduction of data volume while maintaining at least some critical information about the original data. In some embodiments, the system and method can at least partially reduce storage and computational requirements. Further, in some embodiments, the system and method can at least partially reduce communication bandwidth required to transmit data. Some embodiments enable troubleshooting and diagnosing operational problems, while preserving and understanding the extrema and range of signals. In some embodiments, when using this method, the system can transmit, store, manipulate and retrieve data far more efficiently than what could be done otherwise.

Some embodiments of the invention include a computing device coupled to at least one user display and at least one non-transitory computer-readable medium with instructions that when executed by the computing device, cause the computing device to perform operations. In some embodiments, instructions can comprise an algorithm that can be easily adjusted to preserve higher or lower fidelity data. In some further embodiments, when tuned for a higher fidelity than what is present in the actual signal, the algorithm can preserve the original signal without adding any artificial data/distortion.

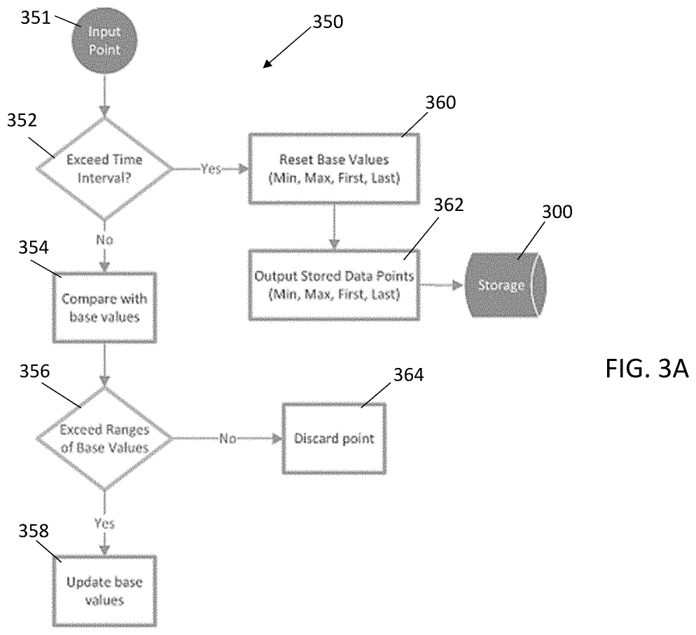

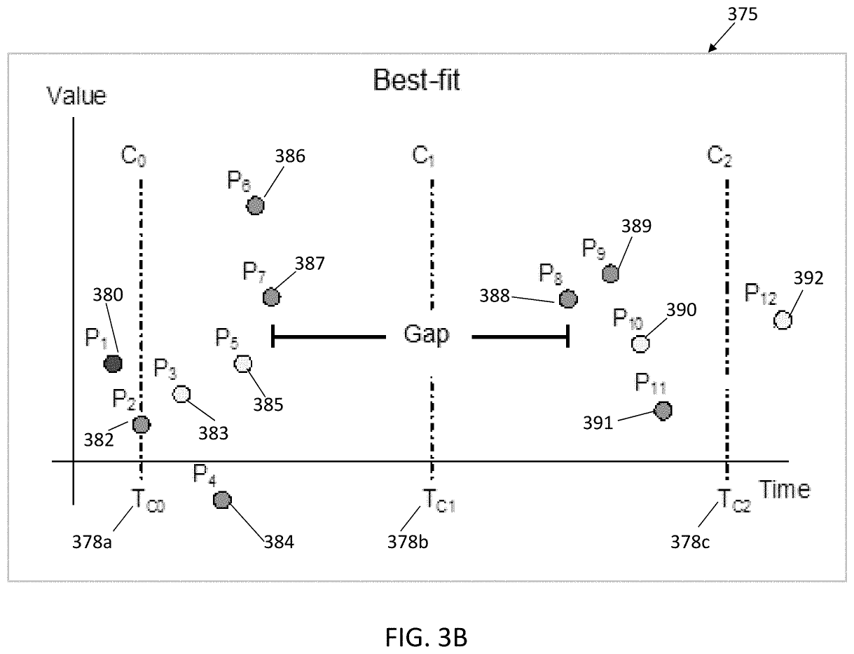

Referring to FIG. 3A, illustrating a process 350 for a best-fit data storage, in some embodiments of the invention, the system and method, from an input point 351, can comprise a step of checking if a time interval has been exceeded (shown as step 352). In some embodiments, if the time interval has been exceeded, the system and method can reset base values (min, max, first, and last) in step 360. Further, in some embodiments, any system operating the process 350 (e.g., such computing device 201) can output stored data points (min, max, first, and last) to storage in step 300. In some embodiments of the invention, if the time interval has not been exceeded, the system and method can compare with base values in step 354, and them check if values exceed ranges of base values. In some embodiments, if the output is negative, the data points can be discarded in step 364. In other embodiments, if the outcome is positive, base values can be updated in step 358.

In some embodiments, the process 350 can operate on a cycle duration. In some embodiments, each cycle can have up to five values, such as a first value, minimum value, maximum value, last value, and an exception value (NULL). In some embodiments, each value coming into the cycle can be evaluated to see if it is a first value in the cycle, a minimum value, maximum value, or a last value.

In some embodiments, once the cycle range is expired, the data points are sent across for storage. In some embodiments, after step 358 is complete, the process 350 is repeated and returns to input point step 351, followed by step 352, etc., and therefore every point is evaluated to see if it is a first value in the cycle, a minimum value, maximum value, or a last value, and the exception value for the cycle.

FIG. 3B shows a non-limiting example of data point selection using a best-fit process of the invention. In the example, a best-fit storage graph 375 includes two cycles between a start time of T_{C0} 378a and an end time of T_{C2} 378c, where T_{C1} 378b represents the end of the first cycle and the start of the second cycle. In some embodiments, the cycle duration is fixed per data source or user, and the resolution is defined by the rate limit (i.e., it is dynamic for each user). As shown, there are twelve points represented by the dots marked P₁ 380 through P₁₂ 392, including P₃ 383, P₄ 384, P₅ 385, P₆ 386, P₇ 387, P₈ 388, P₉ 389, P₁₀ 390, and P₁₁ 391 that pass through these 2 cycles. Of these points eleven represent normal analog values, and one, P₇ 387, represents a NULL due to an I/O server disconnect, which causes a gap in the data between P₇ 387 and P₈ 388. Further, two points, P₁ 380 through P₁₂ 392, are not considered at all for this example as it is outside of the cycle range. All other points are considered, but only the points P₂ 382, P₄ 384, P₆ 386, P₇ 387, P₈ 388, P₉ 389, and P₁₁ 391 are returned. For example, in the first cycle four points can be returned, P₂ 382 as the initial value of the query as well as the first value in the cycle, P₄ 384 as the minimum value in the cycle, P₆ 386 as both the maximum value and the last value in the cycle, and finally P₇ 387 as the first value, and in this case the only value occurring in the exception in the cycle. Further, in the second cycle three points will be returned, P₈ 388 as the first value in the cycle, P₉ 389 as the max value in the cycle and finally P₁₁ 391 as both the min value and the last value in the cycle. As no exception occurs in the cycle, none will be returned.

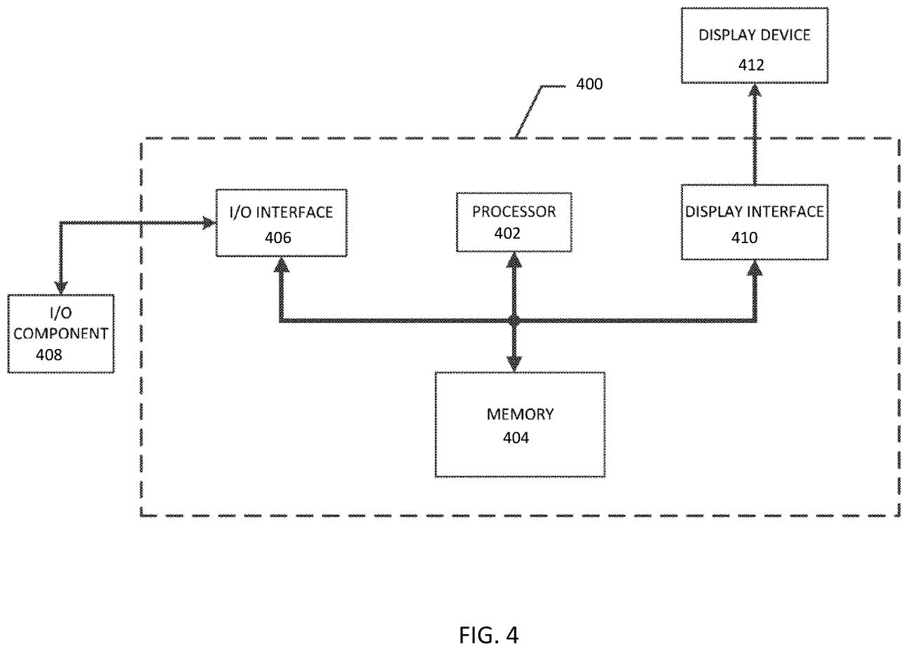

FIG. 4 illustrates a system architecture 400 of the computing device 201 that can operate at least some aspects of the operational historian 111 via a software environment. In this embodiment, the computing device 201 can include at least one processor 402, at least one memory 404, and at least one input/output (I/O) interface 406 that interfaces with at least one I/O component 408. In some embodiments, the memory 404 can comprise storage 300. In some embodiments, the processor 402, memory 404, and I/O interface 406 can be communicatively connected and/or electrically connected to each other. In some embodiments, the I/O interface 406 can be communicatively and/or electrically connected to the I/O component 408. In some embodiments, the processor 402 can be adapted to execute processor-executable instructions stored in the memory 404 for implementing one or more operations of the historian 111. In some embodiments, the I/O interface 406 of FIG. 4 can provide a physical data connection between one or more components of the system architecture 400, and I/O component 408, and any other coupled system, assembly or component, including, but not limited to, any portion of one or more industrial processes such as fluid processing system 310. In some embodiments, I/O interface 406 can be a network interface card (“NIC”) or modem, and I/O component 408 comprises a telecommunications network.

In some embodiments, the system architecture 400 includes a display interface 410 coupled to a display device 412. In some embodiments, the systems and methods of the invention can generate information that can be conveyed to a user in the form of text and/or graphics in a graphical user interface (GUI) generated by the display interface 410 on the display device 412. In some embodiments, the GUI may have a variety of icons indicating different event data, storage blocks, or snapshots, alarms status updates, and utilization data. In some embodiments, the display device 412 that can be any fixed or mobile computing device that can be wired and/or wirelessly coupled to the Internet or through an Intranet and/or Ethernet, including, but not limited to, desktop computers, laptop computers, digital assistants, personal digital assistants, cellular phones, mobile phones, smart phones, pagers, digital tablets, internet appliances, vehicular displays, wearable displays, virtual reality viewing devices such as virtual reality headsets, virtual reality glasses, and the like and other processor-based devices.

In some embodiments, the GUI can comprise an HMI that provides a graphical view/window representing a status or utilization of a process/plant, and/or a specific piece of equipment, and/or component, or portion thereof. In some embodiments, one or more human-machine-interface (HMI) applications 131b can manage an HMI enabling intake and processing of an operators control instructions, and display device status updates. For example, in some embodiments, software instructions stored on a tangible, non-transitory media and executable by a processor can receive data indicative of a manufacturing/process control system being monitored, and can display at least one status or status update of the manufacturing/process control system being monitored, where the status is based on the received data. In addition, some logic instructions can manage a display of graphic elements as part of the user interface, where one or more of the elements is associated with and indicative of a status (e.g., such as an alarm status) of one or more aspects of the manufacturing/process control system being monitored.

Embodiments of the invention may comprise a special purpose computer including a variety of computer hardware, as described in greater detail below. Embodiments within the scope of the invention can also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Any aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Some embodiments include a system for implementing aspects of the disclosure that includes a special purpose computing device in the form of a conventional computer, including a processing unit, a system memory, and a system bus that can couple various system components including the system memory to the processing unit. In some embodiments, the system bus may be any of several types of bus structures including a memory bus or memory controller, a peripheral bus, and a local bus using any of a variety of bus architectures. In some embodiments, the system memory includes read only memory (ROM) and random-access memory (RAM). Further, some embodiments include a basic input/output system (BIOS), containing the basic routines that help transfer information between elements within the computer, such as during start-up, may be stored in ROM. Further, in some embodiments, the computer may include any device (e.g., computer, laptop, tablet, PDA, cell phone, mobile phone, a smart television, and the like) capable of receiving or transmitting an IP address wirelessly to or from the Internet.

In some embodiments, the computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. In some embodiments, the magnetic hard disk drive, magnetic disk drive, and optical disk drive can be connected to the system bus by a hard disk drive interface, a magnetic disk drive-interface, and an optical drive interface, respectively. In some embodiments, the drives and their associated computer-readable media can provide non-volatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including, but not limited to, magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can be accessed by the computer. Alternatively, communication media typically embody computer readable instructions, data structures, program modules or other data in a modulated data signal such as a carrier wave or other transport mechanism and includes any information delivery media.

Some embodiments include program modules comprising program code that may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). In some embodiments, the monitor or another display device is also connected to the system bus via an interface, such as a video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices, including any of the devices disclosed herein.

In some embodiments, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like. Further, in some embodiments, the computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

In some embodiments, when used in a LAN networking environment, the computer can be connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

In some embodiments, the computer-executable instructions are stored in a memory, such as the hard disk drive, and executed by the computer. Advantageously, the computer processor has the capability to perform all operations (e.g., execute computer-executable instructions) in real-time. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Embodiments of the disclosure may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by description herein.

1. A server system comprising;
program logic tangibly stored on at least one non-transitory computer-readable storage medium of a network, the network including at least one processor coupled to a historian, the historian configured to receive operational state data from at least one device of an industrial process of the network, wherein upon execution of at least a portion of the program logic by the at least one processor, the at least one processor is configured to process steps of a method including:
i). receiving input data from the historian during a time interval;
ii). calculating if the time interval has exceeded a specified time interval, and if the time interval has exceeded a specified time interval, then performing the steps of:
a). resetting base data values;
b). outputting stored input data to the at least one non-transitory computer-readable storage medium of the network; and
if the time interval has not exceeded a specified time interval, then performing the step of:
iii). comparing the input data with the base values, and if any of the input data exceeds at least one of the base values, then updating base values and proceed to step i); and
if any of the input data does not exceed at least one of the base values, then discarding the input data and proceeding to step i).

2. The server system of claim 1, wherein the specified time interval comprises at least one cycle duration.

3. The server system of claim 2, wherein the at least one cycle duration comprises a fixed cycle duration dependent on at least one of a data source and at least one user.

4. The server system of claim 3, wherein a resolution of the specified time interval is defined by a rate limit that is dynamic per the at least one user.

5. The server system of claim 1, wherein the specified time interval comprises two cycles.

6. The server system of claim 1, wherein the input data includes time-series data received from the at least one device.

7. The server system of claim 1, wherein the operational state data comprises at least one of metadata, event data, configuration data, raw time-series binary data, tag metadata, and diagnostic log data.

8. The server system of claim 1, wherein the at least one device includes one or more components of a fluid processing system.

9. The server system of claim 8, wherein the one or more components comprise at least one of at least one pump, at least one valve, at least one sensor, and at least one process controller.

10. The server system of claim 1, wherein the base values include a first value in a cycle, a minimum value in the cycle, maximum value in the cycle, a last value in the cycle, and/or an exception value in the cycle.

11. A computer-implemented method comprising the steps of:
i). receiving input data from an operational historian during a time interval, the operational historian coupled to a network and receiving operational state data from at least one device of an industrial process of the network, wherein at least a portion of the input data is derived from at least a portion of the operational state data;
ii). using at least one processor, calculating if the time interval has exceeded a specified time interval, and if the time interval has exceeded a specified time interval, then performing the steps of:
a). resetting base data values;
b). outputting stored input data to at least one non-transitory computer-readable storage medium of the network; and
if the time interval has not exceeded a specified time interval, then performing the step of:
iii). using the at least one processor comparing the input data with base values, and
if any of the input data exceeds at least one of the base values, then updating the base values and proceeding to step i); and
if any of the input data does not exceed at least one of the base values, then discarding the input data and proceeding to step i).

12. The computer-implemented method of claim 11, wherein the specified time interval comprises at least one cycle duration.

13. The computer-implemented method of claim 11, wherein the at least one cycle duration comprises a fixed cycle duration dependent on at least one of a data source and at least one user.

14. The computer-implemented method of claim 11, wherein a resolution of the specified time interval is defined by a rate limit that is dynamic per the at least one user.

15. The computer-implemented method of claim 11, wherein the specified time interval comprises two cycles.

16. The computer-implemented method of claim 11, wherein the input data includes time-series data received from the at least one device.

17. The computer-implemented method of claim 11, wherein the operational state data comprises at least one of metadata, event data, configuration data, raw time-series binary data, tag metadata, and diagnostic log data.

18. The computer-implemented method of claim 11, wherein the at least one device includes one or more components of a fluid processing system.

19. The computer-implemented method of claim 18, wherein the one or more components comprise at least one of at least one pump, at least one valve, at least one sensor, and at least one process controller.

20. The computer-implemented method of claim 11, wherein the base values include a first value in a cycle, a minimum value in the cycle, maximum value in the cycle, a last value in the cycle, and/or an exception value in the cycle.
